(19) United States
(12) Patent Application Publication
(10) Pub. No.: US 2026/0221016 A1
(43) Pub. Date: Jul. 30, 2026

(54) SYSTEMS AND METHODS FOR STORE EXIT VERIFICATION

(71) Applicant: Walmart Apollo, LLC, Bentonville, AR (US)

(72) Inventors: Darrell Whitelaw, Pacific Palisades, CA (US); Brittany N. Leek, Waterford, MI (US); Andrew J. Grignon, Roseville, CA (US); Jae Y. Lew, Mill Valley, CA (US); Stephen S. Hadinger, Berkeley, CA (US)

(21) Appl. No.: 19/151,974

(22) PCT Filed: Jan. 30, 2024
(86) PCT No.: PCT/US2024/013445

§ 371 Date: Jul. 29, 2025

Related U.S. Application Data
(60) Provisional application No. 63/442,357, filed on Jan. 31, 2023.

(51) Int. Cl. G08B 13/196; G06Q 30/0601; G06V 20/52

(52) U.S. Cl. CPC G08B 13/196; G06Q 30/0633; G06V 20/52

(57) ABSTRACT

Store exit verification system and method for retail purchases are provided. The system comprises a sensor array, a display device, and a control circuit. The sensor array collects information from items in a shopping container placed in a shopping container placement area. The control circuit identifies a transaction identifier associated with the shopping container, retrieves an item list associated with the transaction identifier, identifies items in the shopping container based on the information collected via the sensor array, determines whether an intervention condition is present based on a comparison of the item list with the identified items, and indicates a verification completion via the display device if no intervention condition is detected.

### CROSS-REFERENCE TO RELATED APPLICATION(S)

This application claims the benefit of U.S. Provisional Application No. 63/442,357 filed Jan. 31, 2023, which is incorporated herein by reference in its entirety.

### TECHNICAL FIELD

These teachings relates generally to systems and methods for store exit verification.

### BACKGROUND

Retail exit verification is a process implemented at some retail establishment for loss prevention. Currently, after checkout, a customer may be asked to present a paper receipt to a store employee to exit the store. The store employee then verifies the paper receipt against the content of a shopping cart or bag.

### BRIEF DESCRIPTION OF THE DRAWINGS

Disclosed herein are embodiments of systems and methods for an integrated scale system of a checkout terminal for retail transactions. This description includes drawings, wherein:

FIG. 1 is a front view of a store exit verification terminal 100 in accordance with some embodiments.

FIG. 2 depicts the store exit verification terminal 100 in use in accordance with some embodiments.

FIG. 3 is a block diagram of a store exit verification system 300 in accordance with some embodiments.

FIG. 4 is a flowchart depicting an example method 400 for facilitating store exit verification.

FIG. 5 is a flowchart depicting an example method 500 of preliminary steps that may be performed before the steps in FIG. 4.

### DETAILED DESCRIPTION

Generally speaking, pursuant to various embodiments, systems, apparatuses, and methods are provided for store exit verification for retail purchases. In some embodiments, a store exit verification system comprises a sensor array comprising one or more sensing devices to collect information from one or more items in a shopping container placed in a shopping container placement area, a display device, and a control circuit coupled to the sensor array and the display device, the control circuit being configured to identify a transaction identifier associated with a shopping container placed in the shopping container placement area, retrieve an item list associated with the transaction identifier, identify one or more items in the shopping container based on the information collected via the sensor array, determine whether an intervention condition is present based on a comparison of the item list with the one or more items identified, and indicate, in the event that no intervention condition is detected, a verification completion via the display device.

Retail entities often provide customers with multiple ways to purchase items. With the increase in methods of purchasing, there is a need to verify the item leaving retail stores for loss prevention. In some embodiments, the store exit verification terminal 100 may be a system in a retail environment that verifies whether items are purchased and paid for before a customer exits the store with the items. The system may facilitate the processing of verifying the purchased items before a customer exits the store. In some embodiments, the store exit verification terminal 100 may verify items in a shopping container (for example, a shopping cart, a shopping tote, etc.) without removing the items from the shopping container. In some embodiments, the system may verify a plurality of items in the shopping container simultaneously while the items remain in the shopping container such that the system may increase the throughput and improve customer satisfaction. In accordance with some embodiments, the system reduces the shrink rate (the percentage of inventory lost).

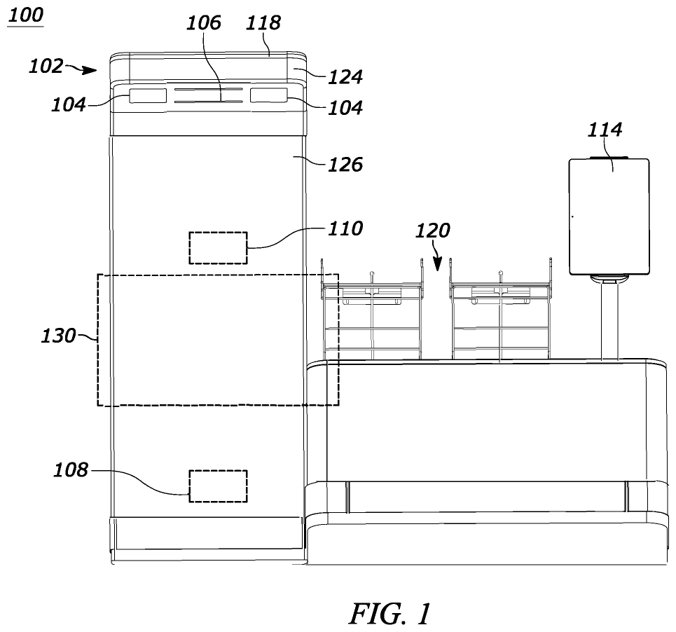

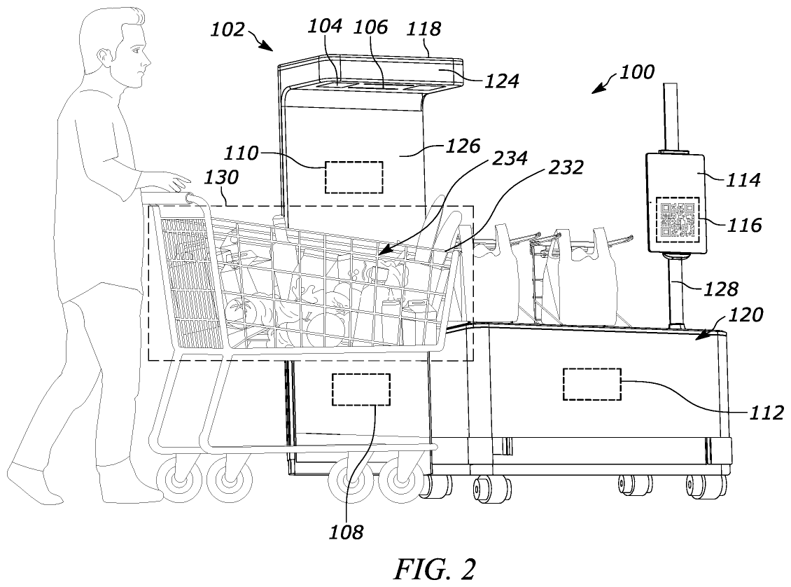

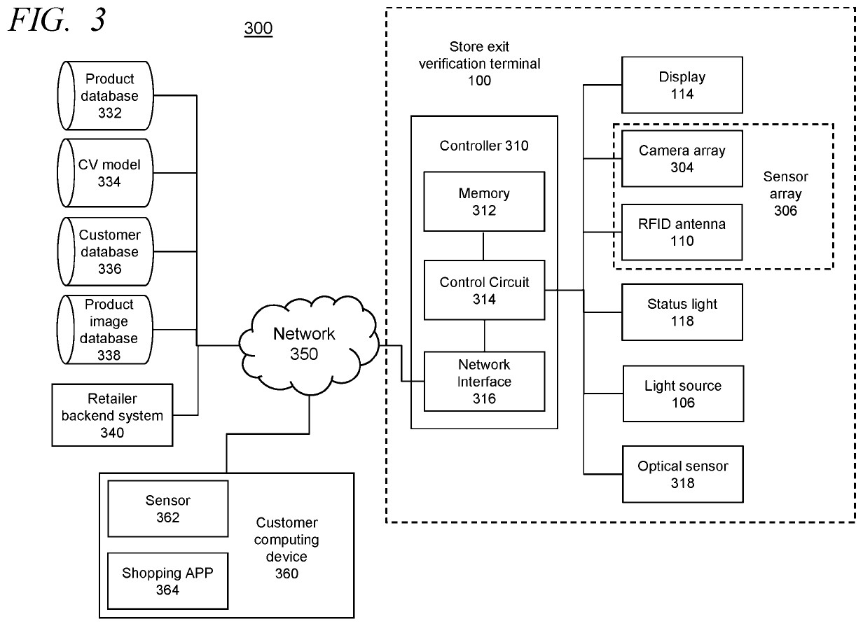

FIG. 1 is a front view of a store exit verification terminal 100 in accordance with some embodiments. FIG. 2 depicts the store exit verification terminal 100 in use in accordance with some embodiments. FIG. 3 is a block diagram of a store exit verification system 300 in accordance with some embodiments. The same reference numbers in FIGS. 1-3 generally refer to the same parts in each figure.

In some embodiments, the store exit verification system 300 comprises a store exit verification terminal 100 comprising one or more sensing devices, a display device 114, and a controller 310. The one or more sensing devices included in the store exit verification terminal 100 may be collectively referred to as a sensor array 306. In some embodiments, the sensor array 306 includes one or more stationary sensors such as one or more stationary overhead cameras.

According to some embodiments, the store exit verification terminal 100 may define a shopping container placement area 130 configured to place a shopping container 232 to verify items 234 in the shopping container 232. The shopping container placement area may be an area where a customer is guided or instructed to place a shopping container 232. The shopping container placement area 130 may be an area within fields of views and/or fields of detection of the one or more sensing devices of the store exit verification terminal 100.

The sensor array 306 may be configured to collect information from one or more items 234 in a shopping container 232 placed in the shopping container placement area 130. The shopping container 232 may be a container that customers use to hold items for purchase while they are shopping. For example, the shopping container 232 may be but is not limited to a shopping cart, a shopping basket, or a shopping tote.

In some embodiments, the information collected by the sensor array 306 may be but is not limited to the appearance of items, symbology identifiers on items, and/or information stored in radio frequency identification antenna (RFID) tags on items. The appearance of items may include but is not limited to size, shape, location of edges, width and height of packages, prints on packages, and so on. Generally, symbology identifiers in the context of product/item identification may refer to visual symbols (e.g., barcode, QR code, product watermark) that encode product identifiers (e.g. UPC, SKU, etc.). In some embodiments, product watermarks may comprise nearly imperceptible repetitive markings on products that cover multiple surfaces of the product to provide product identification from different views, an example being Digimarc watermarking.

In some embodiments, the sensor array 306 may comprise one or more cameras 104 configured to capture images of items and/or symbology identifiers on items 234 in the shopping container 232 placed in the shopping container placement area 130. The one or more cameras of the store exit verification terminal 100, including the cameras 104, may be collectively referred to as a camera array 304. In some embodiments, one or more cameras 104 may be positioned around a shopping container placement area 130 to provide different fields of view of the shopping container placement area.

The camera array 304 may comprise one or more 2D and/or 3D cameras for capturing images of items in the shopping container 232 brought to the shopping container placement area 130. In some embodiments, the 2D and/or 3D cameras may be configured to capture the images of items and/or symbology identifiers on items in the shopping container 232 placed in the shopping container placement area 130. In some embodiments, the 2D cameras may include cameras of different focal lengths. In some embodiments, the 3D cameras may be configured to capture 3D images of products. The 3D cameras may comprise depth-sensing cameras. In some embodiments, the 3D cameras may be used to capture 3D point clouds.

In some embodiments, images captured by both 2D and 3D cameras may be used for symbology detection and/or for computer vision (CV) item identification. In some embodiments, the camera array may include only 2D cameras that are used for both symbology detection and CV. In some embodiments, the camera array may include only 3D cameras that are used for both symbology detection and CV. In some embodiments, the camera array may include a combination of 2D cameras and 3D cameras. In some embodiments, the 2D and/or 3D cameras may be a high-definition (HD) camera.

In some embodiments, the sensor array 306 may further include a radio frequency identification (RFID) antenna 110 configured to detect an RFID tag on items. The RFID antenna 110 may be capable of finding RFID tags in proximity thereto, such that the RFID antenna may detect RFID tags on items in the shopping container placement area 130. The RFID antenna 110 may be paired with an RFID controller. The RFID antenna may transfer signals to the RFID controller such that the RFID controller may read the product/item information stored on RFID tags. In some embodiments, the RFID antenna and RFID controller may be configured to detect product identifiers via RFID tags and determine the quantity associated with each product identifier.

In some embodiments, the store exit verification terminal 100 may include a sensor tower 102. In some embodiments, the sensor tower 102 may include a standing unit 126 and an overhead unit 124. The overhead unit 124 may be connected to and supported by the standing unit 126. The overhead unit 124 may be positioned above the shopping container placement area 130.

In some embodiments, the overhead unit 124 may include at least one camera configured to capture an image of items in a shopping container 232 placed in the shopping container placement area 130 from above the shopping container 232. In some embodiments, the overhead unit 124 may include two or more cameras 104 positioned and angled to provide different fields of view over the shopping container placement area 130. In some embodiments, the one or more cameras 104 may be disposed inside the overhead unit 124, and may capture images from the shopping container placement area 130 through a window (e.g., a glass cover) of the lower surface of the overhead unit 124. In some embodiments, one or more cameras 104 may be embedded in the overhead unit 124. In some embodiments, two high-definition 2D cameras and two 3D cameras may be disposed in the overhead unit 124. In some embodiments, four high-definition 2D cameras may be disposed in the overhead unit 124. The upper portion of a shopping container is generally open to facilitate putting in and taking out the items from the shopping containers. By disposing two or more cameras on the overhead unit 124, which are positioned and angled to provide different fields of view over the shopping container placement area 130, the store exit verification system according to some embodiments may reduce the rate of unidentified items.

In some embodiments, the overhead unit 124 may further include a light source 106. The light source 106 may be configured to affect the lighting condition of objects (including the shopping container 232 and items 234 therein) placed in the shopping container placement area 130 to enhance images captured by the cameras of the system. In some embodiments, the light source 106 may further include a light sensor for measuring the ambient lighting condition. In some embodiments, the light source 106 may be controlled to output lighting with variable color, wavelength, luminosity, and/or angle for controlling the lighting condition of the shopping container placement area 130 to compensate for ambient lighting conditions.

In some embodiments, the store exit verification terminal 100 may further include a status light 118. In some embodiments, the status light 118 may be disposed on the overhead unit 124. The status light 118 may comprise a color-changing indicator (e.g., LED) that indicates the status of the verification process to customers and employees. For example, the status light 118 may indicate whether the store exit verification terminal is available or not and/or whether an intervention condition (details described later) is present or not.

In some embodiments, the standing unit 126 may support and/or hold the overhead unit 124 above the shopping container placement area 130. In some embodiments, the shopping container placement area 130 may be in front of the standing unit 126.

In some embodiments, the RFID antenna 110 may be embedded in the standing unit 124. In some embodiments, the RFID antenna 110 may be embedded in the standing unit 126 and positioned corresponding to the location where items are typically placed when users use a shopping container provided by a retailer as to facilitate the detection of the RFID tags on the items in the shopping container placed in the shopping container placement area. In some embodiments, the RFID controller may be housed within a bagging station.

In some embodiments, the sensor tower 102 may be adjacent to the shopping container placement area 130. the sensor tower 102 may be configured to provide enough space for the shopping container placement area 130 such that a relatively large shopping container may be placed within the shopping container placement area 130. For example, the structure of the sensor tower 102 and the arrangement of the sensor array 306 on the sensor tower 102 may allow an entire shopping container 232 to be positioned with the shopping container placement area 130. In some embodiments, the sensor tower 102 may be configured to allow the shopping container 232 to access the shopping container placement area 130 without lifting the shopping container 232. In some embodiments, the sensor tower 102 and the floor below the overhead unit may form shopping container placement area 130 which may be accessed from the floor level.

For example, as shown in FIG. 2, the shopping container 232 may be a shopping cart. Shopping carts provided by retailers typically have a set of wheels to provide mobility. According to some embodiments, customers may place the shopping cart in the shopping container placement area 130 by pushing the shopping carts. Further, according to some embodiments, the customer may verify the items in the shopping cart without taking out them from the of the shopping cart, such that the system may increase the throughput of the verification. Further reducing customers'effort and time for verifying the items before exiting the store, the system according to some embodiment may increase the customer's satisfaction.

In some embodiments, the camera array 304 may further include one or more cameras positioned to capture the underside of the shopping container 232 placed in the shopping container placement area 130. Shopping carts, provided by the store, generally have a wire mesh structured shopping container (e.g., a basket of a shopping cart) such that the items in the wire meshed container may be seen from the outside (including the underside) thereof. In some embodiments, the one or cameras may be disposed at a position that is lower than the undersurface of the shopping container provided by stores. In some embodiments, the one or more cameras positioned to capture an underside of the shopping container may be disposed on the standing unit 126. For example, the one or more cameras positioned to capture an underside of the shopping container may be disposed at the portion indicated as 108 in FIG. 1. Including the one or cameras configured to capture an underside of the shopping container may allow the system to collect more information of items from the captured images such that the system may reduce the number of items in the shopping container that cannot be identified by the system. In some embodiments, the cameras positioned to capture the underside of the shopping container 232 may be HD cameras. In some embodiments, the shopping cart may comprise one or more additional item holding areas under the basket portion to hold additional items. For example, the shopping cart may include a flat bed or a second basket under the main basket. In some embodiments, the camera array 304 may include cameras positioned to capture images from the additional item holding areas.

In some embodiments, two or more sensing devices of the sensor array 306 may be stationary sensors mounted on a sensor tower 102 adjacent to the shopping container placement area 130 at two more heights. For example, one or more sensing devices of the sensor array 306 may be mounted on the overhead unit 124, and the other one or more sensing devices may be mounted on the standing unit 126. In some embodiments, two or more sensing devices may be mounted on the standing unit 126 at different heights.

In some embodiments, the display device 114 may display information related to the store exit verification to users (e.g., customers and/or employees). For example, the display device 114 may be configured to display a optical code 116 which the customer may scan with a customer computing device 360. In some embodiments, the optical code 116 may encode a terminal identifier which, when scanned by the customer computing device customer computing device 360, is forwarded to a backend server to pair the store exit verification terminal 100 with the customer computing device 360 and the transaction associated with the customer computing device 360. The display device 114 may further display the status of the store exit verification and/or store exit verification instructions. In some embodiments, the display device 114 may display a list of identified item information and information associated with the purchase transaction. For example, the display device 114 may display names and quantities of items as they are identified such that a user and/or an employee may see the identified items. In some embodiments, the display device may further display the list of items that have been purchased/paid for such that the customer and/or employee may compare the list with the content of the shopping container for unidentified items or unpurchased items. In some embodiments, the display device 114 may comprise a touch screen configured to accept user input. In some embodiments, the display device 114 may be a tablet computer having a touch screen. In some embodiments, the display device may be fixed to a supporting pole 128 on a bagging station 120.

In some embodiments, the system may further comprise an optical sensor 318 for reading an optical code encoding a transaction identifier displayed on a screen of a customer computing device or a printed receipt. In some embodiments, the optical sensor may be a sensor fixedly embedded in the store exit verification station such that a customer may allow the optical sensor to read the option code by moving the optical code to the optically detected area of the optical sensor. In some embodiments, the optical sensor 318 may be a hand-held optical scanner such as a Laser or LED barcode scanner. In some embodiments, the optical sensors 318 may be mounted under the display device 114. In some embodiments, one or more cameras on the sensor tower may be used to read the optical code displayed on the customer computing device or on a printed receipt.

The terminal 100 may further include a bagging station 120. Customers may use the bagging station to pack the items after completion of verification if necessary. The bagging station 120 may be disposed near the shopping container placement area 130. By disposing the bagging station 120 near the shopping container placement area 130, the customer may use the bagging station 120 to bag the items in the shopping container 232 without moving a far distance after completion of the verification process. The bagging station 120 may include bag holders for holding store-provided or customer-provided bags or totes. A set of wheels may be attached to the bottom of the bagging station to provide mobility to the bagging station. In some embodiments, the bagging station 120 may house one or more controllers or processors 112 such as the controller 310, a camera array controller, and/or an RFID controller.

Referring to FIG. 3, the store exit verification system 300 includes a controller 310 coupled to a display device 114, a camera array 304, an RFID antenna 110, a status light 118, and a light source 106. In some embodiments, the controller 310 and one or more of the display devices 114, a camera array 304, an RFID antenna 110, a status light 118, and a light source 106 may comprise a store exit verification terminal 100. The controller 310 may communicate with a product database 332, a computer vision (CV) model 334, a customer database 336, and a product image database 338 to retrieve and store information. The controller 310 may also communicate with the retailer backend system 340 for processing retail transactions including the store exit verification.

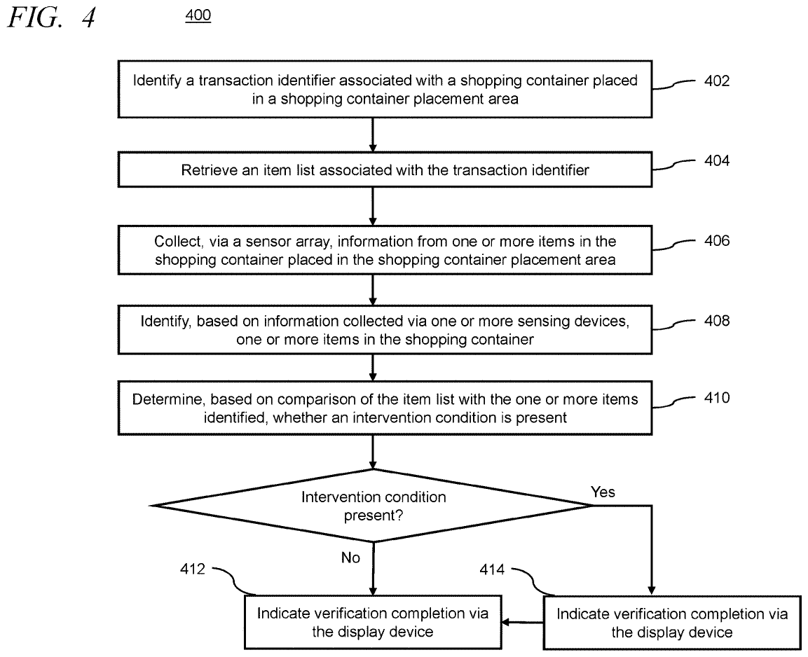

The controller 310 comprises a control circuit 314, a memory 312, and a network interface device 316. In some embodiments, the controller may be housed in the bagging station 120. Placing the controller 310 in the bagging station may reduce the volume of the verification terminal 100, such that the system in some embodiments may increase the space efficiency. The control circuit 314 may comprise one or more of a processor, a microprocessor, a central processing unit (CPU), a graphics processing unit (GPU), an application-specific integrated circuit (ASIC), an RFID processor, and the like and may be configured to execute computer-readable instructions stored on a computer-readable storage memory 312. The computer-readable storage memory 312 may comprise volatile and/or non-volatile memory and have stored upon it, computer-readable instructions which, when executed by the control circuit 314, causes the control circuit 314 to perform necessary steps to verify whether the items in the shopping container in the shopping placement area are purchased and fully paid. In some embodiments, the computer-executable instructions may cause the control circuit 314 of the controller 310 to perform one or more steps described with reference to FIG. 4 herein.

The network interface device 316 of the controller 310 may comprise a data port, a wired or wireless network adapter, and the like. In some embodiments, the controller 310 may communicate with the retailer backend system 340 and one or more of the product database 332, the CV model 334, customer database 336, and product image database 338 via one or more networks 350 such as a local network, a private network, or the Internet.

In some embodiments, the controller 310 may be in communication, over the one or more communications networks 350 with customer computing devices 360, each associated with a respective customer and temporarily at the retail facility as the customers are at one of the retail stores. The customer computing device may be but not be limited to a customer mobile device or wearable device. At least some of the customer computing devices 360 may include a sensor 362 and store and execute one or more customer applications (APPs), including but not limited to a cart compile and/or self-purchase application (shopping APP) 364. The shopping APP 364 may enable the customer to identify, through the customer computing device 360, one or more items intended to be purchased, and in some instances complete a purchase of the one or more items identified via the customer's payment for the items. Such identification of items for purchase can be identified through one or more methods and/or techniques, such as but not limited to selection from a listing of one or more items displayed on the computing device, image recognition of an item, optical scanning of a unique optically scannable identifier (e.g., barcode, QR code, etc.), optical character recognition (OCR), other such methods or a combination of two or more of such methods. For example, item recognition can be achieved through one or more methods as described in one or more of U.S. Pat. No. 10,121,133 entitled Method For Self-Checkout With A Mobile Device; U.S. Pat. No. 10,872,326 entitled Systems And Methods Of Product Recognition Through Multi-Model Image Processing; and U.S. Pat. No. 11,263,682 entitled System And Method For Coupling A User Computing Device And A Point Of Sale Device; each of which is incorporated herein by reference in its entirety. In some embodiments, the items for purchase may be identified via images captured by the sensor 362 comprising a camera.

The product database 332 may comprise a computer-readable memory storage storing product information. In some embodiments, the product database 332 may store information used for identifying items such as product identifiers (e.g. stock keeping unit (SKU) code, universal product code (UPC), European article number (EAN), etc.), product names, product weight, product characteristic (e.g. variable weight, fixed weight), and product display location associated with products for sale.

The CV model 334 comprises a machine learning algorithm trained object identification model configured to identify products via artificial intelligence (AI) and machine vision. In some embodiments, product identifiers (e.g. UPC, SKU) and 2D and/or 3D images of products captured by store exit verification terminals or other types of retail checkout terminals may be used to train the CV model to recognize products. In some embodiments, images from other sources such as manufacturer images, online images, customer-captured images, etc. may also be used to train the CV model. In some embodiments, the CV model comprises a deep neural network model trained using 2D and/or 3D product images as input and product identifiers as categorizations. In some embodiments, the CV model is configured to take product images as input and output one or more product identifiers each associated with a confidence level. In some embodiments, the store exit verification terminal 100 may be connected to a CV service that processes captured images, identifies items based on the CV model, and provides item identification information back to the store exit verification terminal 100. In some embodiments, a CV algorithm using the CV model may be executed locally at the controller 310. In some embodiments, the CV model may also be trained to identify objects that are not products for sale, such as customers'personal items like reusable shopping bags, keys, wallets, mobile phones, beverage containers, etc.

The customer database 336 stores information on customers. In some embodiments, the customer database 336 may store membership information and/or past purchase history associated with customers.

The product image database 338 is configured to store product identifiers and associated product images from the manufacturers, vendors, and suppliers, or aggregated from the web. In some embodiments, the images in the product image database 338 may be used to match items detected by the camera array 304 and items identified based on symbology and/or RFID. For example, when an item is identified through symbology and/or RFID, image(s) associated with the detected item identifier may be retrieved from the product image database 338 and compared to the captured images of items in the placement area. In some embodiments, images in the product image database 338 may also be used to train the CV model 334 or a separate product image model for similarity comparison, and the matching of detected and RFID or symbology-identified items may be based on the trained model.

In some embodiments, one or more of the product database 332, the CV model 334, the product image database 338, the customer database 336, and the product image database 338 may be implemented on one or more local, remote, or cloud-based storage and/or be at least partially stored locally at the memory 312 of the controller 310 of the store exit verification terminal 100. In some embodiments, one or more of the product database 332, the CV model 334, the product image database 338, and the customer database 336 may be updated and/or accessed by a plurality of store exit verification terminals in geographically distributed locations and may be considered part of the retailer backend system 340.

The retailer backend system 340 may comprise retailer systems such as an inventory system, a transaction processing system, a payment processing system, etc. that support the processing of verification at the store exit verification station.

FIG. 4 is a flowchart depicting an example method 400 for facilitating store exit verification. In some embodiments, the steps shown in FIG. 4 may be performed by a processor-based device such as a control circuit executing a set of computer-readable instructions stored on a computer-readable memory. In some embodiments, one or more steps of FIG. 4 may be performed by the store exit verification system 300 including the store exit verification terminal 100 described with reference to FIGS. 1-3.

Before initiating the store exit verification, a user may pay for the items in the shopping container. In some embodiments, a customer may pay for items in the shopping container 232 by a self-checkout via the shopping APP 364 installed on the customer computing device 360. In some embodiments, a customer may pay for items in the shopping container with a payment device (e.g., a self-service retail kiosk) provided by a retailer. The method of paying for the items in the shopping container may not be limited to the methods described herein. The payment process may be conducted via the retailer backend system.

Once the customer completes the payment of the items in the shopping container, the retailer backend system may generate a transaction identifier associated with the transaction of the items in the shopping containers. In some embodiments, the retailer backend system may send the transaction identifier to the customer computing device 360.

To initiate the store exit verification, a user may place the shopping container having the purchased items in the shopping container placement area of the verification station. In some embodiments, the control circuit 314 may send signals to the display device such that the display device displays instructions for placing the shopping container in the shopping container placement area (e.g., under the overhead unit). In some embodiments, when the customer has paid for the items in the shopping container via the shopping APP installed on the customer computing device 360, the APP may provide instructions for placing the shopping container containing the paid/purchased items in the shopping container placement area 130. In some embodiments, the system may present customer instructions for placing the shopping container in the shopping container placement area without taking out the items from the shopping container.

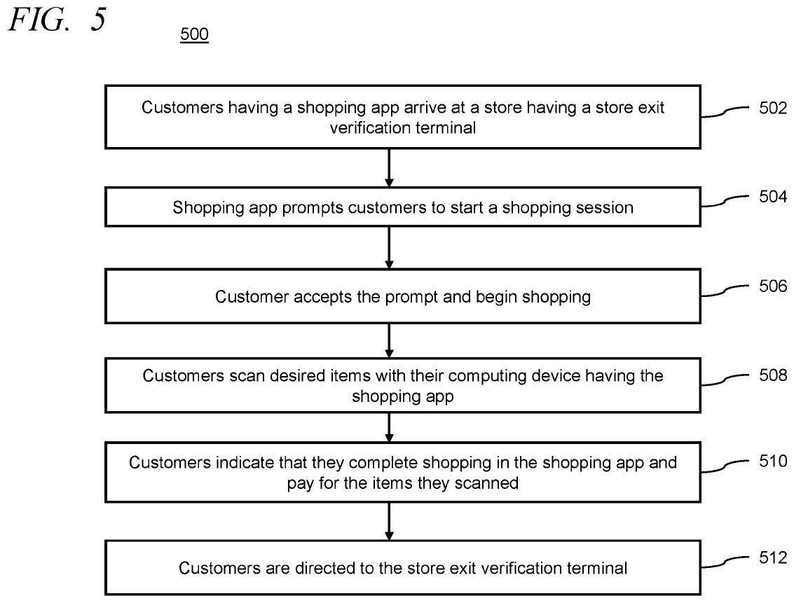

FIG. 5 is a flowchart depicting an example method 500 of preliminary steps that may be performed before the steps in FIG. 4. In step 502, customers with a customer computing device on which a shopping app (e.g., the WALMART's shopping app “SCAN&GO”) has been installed arrives at a store having the store exit verification terminal 100. In step 504, the shopping app prompts the customers to start a shopping session on the shopping app. In step 506, the customers accept the prompt and begin shopping. In step 508, the customers scan each desired item with their computing device (e.g., smartphone) having the shopping app. In step 510, the customers indicate that they complete shopping in the shopping app and pay for items they scanned. In some embodiments, the customers may pay via a payment interface and/or with a digital wallet using a previously stored payment method. In step 512, customers are directed to the store exit verification terminal 100 for verification.

Referring to FIG. 4, in step 402, the control circuit of the controller 310 may identify the transaction identifier associated with a shopping container placed in the shopping container placement area. The transaction identifier associated with the shopping container placed in the shopping container placement area may be the transaction identified generated when the customer pays for the items in the shopping container placed in the shopping container placement area. Some embodiments for generating and identifying the transaction identifier associated with the shopping container placed in the shopping container placement area may be described herein, but methods and apparatuses to generate and identify the transaction identifier may not be limited to the described methods and apparatuses.

In some embodiments, when a customer pays for items in the shopping containers 232 by a self-checkout via the shopping APP 364 installed at the customer computing device 360, the customer computing device then may display an optical code encoding the transaction identifier via a screen of the customer computing device. In some embodiments, when a customer pays for items in the shopping container with a payment device (e.g., a retail kiosk) provided by a retailer, a receipt printed by the payment device may include an optical code encoding the transaction identifier associated with the payment of the items in the shopping container. In some embodiments, the optical sensor of the system may read the optical code displayed on a screen of a customer computing device or the optical code on the printed receipt. When the optical sensor of the system read the optical code on the receipt, the control circuit may decode the optical code and identify the transaction identifier associated with the item in the shopping container.

In some embodiments, the store exit verification system may display via the display device a verification code being configured to instruct a user mobile device scanning the verification code to provide the transaction identifier to the control circuit. For example, when the customer pays for the items in the shopping container with the shopping APP 364 installed on the customer computing device, the retailer backend system 340 may generate a transaction identifier associated with the payment of the items in the shopping container to the customer computing device 360. In some embodiments, the retailer backend system 340 may send the generated transaction identifier to the customer computing device 360 and/or the customer computing device 360 may retrieve the transaction identifier from the retailer backend system. When the customer computing device having the shopping APP 364 with which the customer has paid for the items in the shopping container reads the optical code 116 on the display device of the store exit verification terminal 100, the customer computing device 360 may decode the verification code and provide the transaction identifier to the control circuit 314. In these embodiments, the store exit verification terminal 100 may not include an optical sensor 318 to read the optical code encoding the transaction identifier.

In step 404, the control circuit 314 may retrieve an item list associated with the transaction identifier. The control circuit 314 may retrieve the item list associated with the transaction identifier from the retailer backend system 340. The item list may comprise a list of items paid via the transaction which generated the transaction identifier identified by the control circuit 314.

In step 406, the sensor array comprising one or more sensing devices may collect item-related information related to the items from the items. The sensor array may include a camera array and an RFID antenna. In step 406, the camera array may capture the images of items and symbology identifiers on the items in the shopping container. The RFID antenna may detect an RFID tag on items in the shopping container. The RFID antenna may transfer a signal to the RFID controller to deliver the information of the detected RFID tag and the RFID controller may read the item information stored in the RFID tag. The RFID controller may determine the quantity associated with each product identifier. In some embodiments, the method 400 may not include a step of taking out items from the shopping container before step 406.

In step 408, the control circuit 314 may identify one or more items in the shopping container placed in the shopping container placement area based on the information collected via the sensor array. In some embodiments, the control circuit 314 may identify the items in the shopping container based on the images of items captured via the camera array, the symbology identifiers on items captured via the camera array, and/or item information stored in the RFID tags detected via the RFID antenna.

To identify items the control circuit 314 may use 2D images, a 3D point cloud, or a combination of 2D and 3D image data. In some embodiments, step 408 may be based on edge detection in 2D or 3D. In some embodiments, the system may capture a 3D point cloud of the objects in the placement area, detect the edge of each object in the 3D point cloud, and draw boundary lines for the objects based on the detected edges. In some embodiments, the items in the shopping container may be identified using a machine learning algorithm based on computer vision models. In some embodiments, the CV algorithm may use a CV model trained based on machine learning to identify products based on previously captured images of products as input and product identifiers as categorizations. In some embodiments, the CV model may comprise a deep neural network object recognition model. In some embodiments, the CV model may be trained based on images captured during checkout processes at a plurality of geographically distributed checkout terminals including the store exit verification stations. In some embodiments, the CV algorithm may take 2D and/or 3D images captured by the camera of the checkout terminal as input and output one or more product identifiers (e.g. SKU, UPC) as product identification. In some embodiments, the CV model may further output a confidence level to each product identification. In some embodiments, the system may have a predetermined confidence threshold (e.g. 90%, 95%), and product identifiers outputted by the CV model with a confidence level below the threshold may be marked as an object unrecognized by CV. In some embodiments, item identification may be based on performing one or more steps of PCT Application No. US 2022/44365 filed on Sep. 22, 2022, titled “Checkout Terminal” the entirety of which are incorporated herein by reference.

In step 408, the control circuit may further identify the items based on the detected symbology in the captured images of the items. In some embodiments, an array of high-resolution 2D cameras may be used to perform symbology detection. In some embodiments, the control circuit may be configured to detect barcodes, QR codes, and/or product watermarks in the images. In some embodiments, symbology detection may be based on a machine vision algorithm configured to detect barcodes, QR codes, and/or product watermarks in images. In some embodiments, CV is also used to determine the number of products associated with each product identifier detected based on symbology. For example, edge detection and/or orientation detection may be used to determine whether product watermarks encoding the same product identifier belong to one item or multiple items placed close together.

In step 408, the control circuit may further identify the items in the shopping container based on the item information read by the RFID controller.

In some embodiments, the control circuit 314 may identify the items in the shopping container based on at least two or all of the images of items captured via the camera array, the symbology identifiers on items captured via the camera array, and/or item information stored in the RFID tags detected via the RFID antenna. For example, the control circuit 314 may aggregate all information collected via the sensor array and use the aggregated information in identify the items in the shopping container.

By using the aggregated information, the system may identify the items in the shopping cart without taking out the items from the shopping container. Further, in some embodiments, the system may reduce the number of items that cannot be identified via the sensor array.

In step 410, the control circuit may determine whether an intervention condition is present based on a comparison of the item list comprising the list of items that have been paid, and the identified items. The control circuit may determine that the intervention condition is present when the system fails to identify some or all of the items in the shopping container, the system identifies a greater number of items from the shopping container than the number of items in the item list, and/or the system identifies an item not listed in the item list.

In step 414, when the system determines that one or more intervention condition is present, the control circuit may send a signal to a display device or a status light to indicate that the intervention condition is present .. For example, the control circuit may send a signal to change the color of the status light from a first color indicating no intervention condition to a second color indicating that an intervention condition exists. The first color may also indicate the status that the store exit verification station may be available. The changing color may notify an employee to assist with an intervention condition. In some embodiments, when the control circuit determines there is at least one intervention condition, the control circuit may send a signal to the display device to present the intervention condition via the display device. In some embodiments, after a store associate manually verifies the content of the shopping container, the store associate may enter a store associate code at the terminal and/or mark the transaction as verified in a store associate user device. After the transaction has been successfully manually verified, the process may proceed to step 412. In some embodiments, the customer user device may then display an exit pass indicating the transaction as being verified.

In step 412, the control circuit may send a signal to a display device to indicate a verification completion via the display device when there the intervention condition is not present. For example, the verification completion may be exit instructions presented on the display screen of the display device. By indicating the verification completion on the display device, the system may notify the customer that purchase verification has been completed. In some embodiments, the customer user device may then display an exit pass indicating the transaction as being verified. In some embodiments, the customer user device may then display an exit pass indicating the transaction as being verified.

In some embodiments, a store exit verification system comprises a sensor array comprising one or more sensing devices to collect information from one or more items in a shopping container placed in a shopping container placement area, a display device, and a control circuit coupled to the sensor array and the display device, the control circuit being configured to identify a transaction identifier associated with a shopping container placed in the shopping container placement area, retrieve an item list associated with the transaction identifier, identify one or more items in the shopping container based on the information collected via the sensor array, determine whether an intervention condition is present based on a comparison of the item list with the one or more items identified, and indicate, in the event that no intervention condition is detected, a verification completion via the display device.

In some embodiments, a store exit verification method comprises identifying, with a control circuit coupled to a display device and a sensor array comprising one or more sensing devices, a transaction identifier associated with a shopping container placed in a shopping container placement area, retrieving, with the control circuit, an item list associated with the transaction identifier, collecting via the sensor array comprising one or more sensing devices, information from one or more items in the shopping container placed in the shopping container placement area, identifying, with the control circuit and based on information collected via the one or more sensing devices, one or more items in the shopping container, determining, with the control circuit and based on comparison of the item list with the one or more items identified, whether an intervention condition is present, and indicating, with the control circuit and via the display device in the event that no intervention condition is detected, a verification completion.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A store exit verification system comprising:
a sensor array comprising one or more sensing devices to collect information from one or more items in a shopping container placed in a shopping container placement area, wherein the sensor array comprises one or more stationary overhead cameras mounted above the shopping container placement area;
a display device; and
a control circuit coupled to the sensor array and the display device, the control circuit being configured to:
identify a transaction identifier associated with a shopping container placed in the shopping container placement area;
retrieve an item list associated with the transaction identifier;
identify one or more items in the shopping container based on the information collected via the sensor array;
determine whether an intervention condition is present based on a comparison of the item list with the one or more items identified; and
indicate, in an event that no intervention condition is detected, a verification completion via the display device.

2. The store exit verification system of claim 1, wherein the item list comprises a list of paid items.

3. The store exit verification system of claim 1, wherein the shopping container placement area is an area within fields of views and/or detections of the one or more sensing devices.

4. The store exit verification system of claim 1, wherein the sensor array comprises one or more cameras configured to capture images of items in the shopping container placement area, and the one or more items are identified based on the images captured by the one or more cameras.

5. The store exit verification system of claim 4, the one or more items are identified using a machine learning algorithm based on computer vision models.

6. The store exit verification system of claim 1, wherein the sensor array comprises one or more cameras configured to capture symbology identifiers on items in the shopping container placement area, and the one or more items are identified based on the symbology identifiers captured by the one or more cameras.

7. The store exit verification system of claim 1, wherein the sensor array further comprises a radio frequency identification (RFID) antenna configured to detect an RFID tag on items.

8. The store exit verification system of claim 1, wherein the sensor array comprises one or more cameras configured to capture at least one of images of items and symbology identifiers on items and an RFID antenna configured to detect an RFID tag on items from the shopping container placement area, and the one or more items are identified based on at least two of:
the images of items captured via the one or more cameras;
the symbology identifiers on items captured via the one or more cameras; and
item information stored in the RFID tags detected via the RFID antenna.

9. The store exit verification system of claim 1, wherein the sensor array comprises cameras positioned and angled to provide different fields of view over the shopping container placement area.

10. The store exit verification system of claim 1, wherein the sensor array comprises a set of overhead cameras positioned above the shopping container placement area.

11. The store exit verification system of claim 1, wherein the sensor array comprises at least four high-definition (HD) cameras positioned above the shopping container placement area.

12. The store exit verification system of claim 1, wherein the sensor array comprises at least one HD camera positioned to capture an underside of the shopping container placed in the shopping container placement area.

13. The store exit verification system of claim 1, wherein the display device is configured to display a verification code, the verification code being configured to instruct a user mobile device scanning the verification code to provide the transaction identifier to the control circuit.

14. The store exit verification system of claim 1, further comprising an optical sensor for reading an optical code encoding the transaction identifier displayed on a screen of a user device or a printed receipt.

15. The store exit verification system of claim 1, wherein the intervention condition comprises at least one of:
failing to identify, based on the information captured, some or all of the one or more items in the shopping container;
identifying, based on the captured information, more items than the item list; and
identifying, based on the captured information, an item not listed in the item list.

16. The store exit verification system of claim 1, further comprising a status light configured to indicate a status associated with the intervention condition.

17. The store exit verification system of claim 1, further comprising a bagging station near the shopping container placement area.

18. The store exit verification system of claim 17, wherein the controller circuit and/or an RFID controller are housed within the bagging station.

19. The store exit verification system of claim 1, wherein two or more sensing devices of the sensor array are mounted on a sensor tower adjacent to the shopping container placement area at two more heights.

20. The store exit verification system of claim 1, wherein the one or more sensing devices of the sensor array are mounted on a sensor tower and the shopping container is positioned adjacent to the sensor tower while the one or more devices of the sensor array senses the shopping container.

21. The store exit verification system of claim 20, wherein the sensor tower comprises an overhead unit mounting one or more sensing devices of the sensor array and the shopping container is positioned under the overhead unit while the one or more devices of the sensor array senses the shopping container.

22. A store exit verification method comprising:
identifying, with a control circuit coupled to a display device and a sensor array comprising one or more sensing devices, a transaction identifier associated with a shopping container placed in a shopping container placement area, wherein the sensor array comprises one or more stationary overhead cameras mounted above the shopping container placement area;
retrieving, with the control circuit, an item list associated with the transaction identifier;
collecting via the sensor array comprising one or more sensing devices, information from one or more items in the shopping container placed in the shopping container placement area;
identifying, with the control circuit and based on information collected via the one or more sensing devices, one or more items in the shopping container;
determining, with the control circuit and based on comparison of the item list with the one or more items identified, whether an intervention condition is present; and
indicating, with the control circuit and via the display device in an event that no intervention condition is detected, a verification completion.
